(19) United States
(12) Patent Application Publication
(10) Pub. No.: US 2006/0037057 A1
(43) Pub. Date: Feb. 16, 2006

(54) Method and system of enabling trick play modes using HTTP GET

(75) Inventor: Shugong Xu, Vancouver, WA (US)

Correspondence Address: ROBERT D. VARITZ, 4915 S.E. 33RD PLACE, PORTLAND, OR, 97202, US

(73) Assignee: Sharp Laboratories of America, Inc.

(21) Appl. No.: 10/852,932

(22) Filed: May 24, 2004

(51) Int. Cl. H04N 7/173

(52) U.S. Cl. 725/90

(57) ABSTRACT

A method of providing operational commands to a AV program transmitted using HTTP protocol includes storing an AV program in a server; generating meta data in the server, wherein the meta data includes a mapping table associating time ranges for the AV program to byte ranges for the AV program; transmitting the meta data and mapping table to a client/player associated with the server; generating and transmitting a HTTP GET command from the client/player to the server as a function of a desired operational command; and selecting appropriate I-frames in the server and transmitting the I-frames to the client/player in response to the HTTP GET command.

### FIELD OF THE INVENTION

This invention relates to provision of VCR-like commands to streaming AV, and specifically to a method of allowing a player to issue commands to skip ahead or skip back in an AV stream.

### BACKGROUND OF THE INVENTION

HTTP is a widely used protocol in the Internet and World Wide Web. HTTP GET (Hyper Text Transfer Protocol Group Execute Trigger) is used to retrieve content, such as a web page, from a HTTP server by a HTTP client. It is defined as one of the ways to provide AV transport capability in Universal Plug and Play (UPnP) and Digital Home Working Group (DHWG) protocols. However, HTTP GET, as it exists at this time, cannot easily be used to provide all desired AV capability, such as “trick modes.” Here “trick mode” means the VCR-like operations, such as fast forward, rewind, seek, etc. The major reason that HTTP GET is not capable of performing these operations is that HTTP does not understand time ranges, which are required for DVD/VCR-like operations and trick modes: HTTP only understands file byte ranges. For example, if a DVD player is commanded to enter fast forward mode, it normally just plays some I-frames by indicating the time of the I-frame. Considering that, to enter trick mode for streaming AV, the AV data must be obtained from a server and sent to the client for display, and that the file cannot be obtained but only a few times faster than normal play, because of network constraints, the server must be informed of the exact file location of the needed I-frame. However, because of the variable bit rate (VBR) nature of MPEG2-PS content, the file byte range is not easily estimated from the client side, which has only time range information.

In DHWG, Sony and Thomson propose two methods to address this issue. However, both of the methods require change/modification to the HTTP protocol, including the introducing of a new header to allow HTTP to understand time range information. Media transport section submission, MT-Sony, -1Rev1. November 2003; Device Discovery control and Media Management section submission, P_THOMSON_{—}1_Rev2.

U.S. Pat. No. 6,615,253 B1 for Efficient server side data retrieval for execution of client side applications, to Bowman-Amuah, granted Sep. 2, 2003, describes efficient retrieval of data. A total amount of data required for an application executed by a client is determined. In a single call, the total amount of data from a server is requested over a network. All of the data is bundled into a data structure by the server in response to the single call. The bundled data structure is sent to the client over the network and the data of the data structure is cached on the client. The cached data of the data structure is used as needed during execution of the application on the client.

U.S. Patent Publication No. 20040003400 A1 for System and method for construction, delivery and display of iTV content, of Carney et al., published Jan. 1, 2004, describes creation of iTV content and deployment thereof using a server component adapted to allow content developers to create applications according to an authoring specification which describes a framework for the same. A transport component is configured to optimize and deliver the applications to one or more clients, and a client component is adapted to render the applications through, e.g., a television, so as to permit user interaction therewith. The authoring specification provides for the presentation of content through one or more templates defined therein, allowing application definition and behavior to remain common across multiple client device types, middleware platforms, and/or iTV operating environments. The framework for applications accommodates advertising, promotions, content placement packages and/or programming campaign definitions, so as to permit a selection of a specific advertisement, promotion or content at a time of preparation of the iTV content by the server, and/or a time of execution of the applications by the client.

U.S. Patent Publication No. 20030229900 A1 for Method and apparatus for browsing using multiple coordinated device sets, of Reisman, published Dec. 11, 2003, describes a system and method for navigating hypermedia using multiple coordinated input/output device sets, allowing a user to control what resources are presented on which device sets, regardless of device integration, and provides for coordinating browsing activities to enable such a user interface to be employed across multiple independent systems. It also support new and enriched aspects and applications of hypermedia browsing and related business activities.

### SUMMARY OF THE INVENTION

A method of providing operational commands to a AV program transmitted using HTTP protocol includes storing an AV program in a server; generating meta data in the server, wherein the meta data includes a mapping table associating time ranges for the AV program to byte ranges for the AV program; transmitting the meta data and mapping table to a client/player associated with the server; generating and transmitting a HTTP GET command from the client/player to the server as a function of a desired operational command; and selecting appropriate I-frames in the server and transmitting the I-frames to the client/player in response to the HTTP GET command.

A system for providing operational commands to a AV program transmitted using HTTP protocol includes an AV program stored in a server; meta data generated by the server, including a mapping table associating time ranges for the AV program to byte ranges for the AV program; a client/player associated with the server, which receives the meta data and the mapping table; a HTTP GET command generated by the client/player and sent to the server as a function of a desired operational command; and selection means in the server for selecting appropriate I- frames in the server, which I-frames are sent to the client/player in response to the HTTP GET command.

It is an object of the invention to provide DVD/VCR-like commands to streaming AV.

It is a further object of the invention to provide a meta-file associated with a stream AV program to relate time-range to location range of the AV program.

It is another object of the invention to provide a method of allowing a player to issue commands to skip ahead or skip back in an AV stream.

This summary and objectives of the invention are provided to enable quick comprehension of the nature of the invention. A more thorough understanding of the invention may be obtained by reference to the following detailed description of the preferred embodiment of the invention in connection with the drawings.

### BRIEF DESCRIPTION OF THE DRAWINGS

FIG. 1 is a block diagram of the invention.

### DETAILED DESCRIPTION OF THE PREFERRED EMBODIMENTS

The method of the invention provides a trick mode capability without any change to the HTTP protocol or the HTTP server. The basic concept of the method of the invention is to generate meta data, which may be in the form of a packet, a meta-file, or an index file, for each AV media file which may be used by trick mode, and which contains a mapping table, providing conversion from file size range to the time range. Before the trick mode can be used, the meta data is transmitted to the player. The player uses the meta-file to determine the range of HTTP GET to fetch the correct data from the AV server. As previously noted, HTTP does not understand time range, however, the trick mode relies on time range to “simulate” the DVD/VCR-like commands. Known HTTP GET methods all require a change to the basic HTTP protocol, the server and the client. The method of the invention provides an alternative technique, which does not require a change is necessary to HTTP protocol.

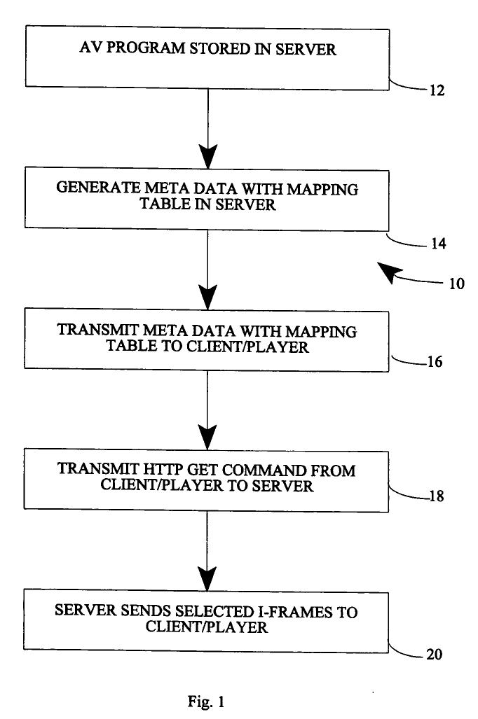

The invention, and now referring to FIG. 1, where the invention is depicted generally at 10, includes storage of an AV program in a server, 12, and (1) meta data, in the form of a meta file, an index file, or a packet, containing a mapping table, is generated 14 by and transmitted 16 from the server side to the client side; and (2) use, by the client side, of the information in the index file to map the time range to byte range, which will send to the server side along with the HTTP GET command. The generated meta data may, or may not, be stored in the server.

Meta data is generated by the server for each AV media file, which contains a mapping table, mapping file size (byte) range to a time range. The mapping may be as simple as Table 1:

TABLE 1
Meta Data Information

| Relative Time | File Access Point | Data-block Size |
|---|---|---|
| 00:02:40 | 124k | 10k |

Thus, when the player wants to access the picture at 00:02:40, it issues a HTTP GET 18 of 10 k byte data from 124 k point. For example, the start point, i.e., file access point, of each I-frame for MPEG2-PS is recorded and sent from the server to the client 20, which will enable the player to perform operations such as fast seek, fast forwards, rewind, etc. The server includes selection means for selecting appropriate I-frames in the server, which I-frames are sent to the client/player in response to the HTTP GET command. It will be understood by one of ordinary skill in the art that Table 1 is only one of many possible way in which to construct the detailed file format of the mapping file. Other formats will also work so lang as they provide the information to map between the file byte range and the time range of the AV content.

Before the trick mode may be used, the meta data is transmitted to the client/player, and the client/player uses the meta data to determine the range of HTTP GET, and to fetch the correct data from the server side. The method of the invention is operable with video clip files stored in a server, network-capable DVD servers, audio files, AV presentation archives, etc.

Assume that a server contains a stored MPEG2 video file, which is two hours long. A “time-range” index file is associated with the video file, which contains the time-range-to-location-range mapping information of one I-frame in every 2 second segment of the video file. The granularity may be changed, which is an implementation choice. In this example, by encoding the mapping information for each chosen I frame into 10 bytes, the index file size will be around 36 k byte for this 2-hour-long multiple gigabyte video file.

Before DVD/VCR-like operations may be performed using trick mode, the index file is transmitted from the server to the client/player side by HTTP GET, without transferring the large media file. The user may then use the meta data and mapping table, stored in the client player, to perform the following actions:
Seeking: the media player may issue a HTTP GET command to get a frame of the video from the second minute, the tenth minute, the fiftieth minute, the sixty-third minute, etc., whatever the user desires to watch.
Fast forward (FF): various FF speeds are possible. The media player issues a HTTP GET containing a series I-frame location ranges based on the time range the viewer desires to see. An example, for a ten-second FF skip, at the 110th second of the video is for the player to issue a commend to get I-frames at 110 seconds, 120 seconds, 130 seconds, etc.

Thus, a method and system of enabling trick play modes using HTTP GET has been disclosed. It will be appreciated that further variations and modifications thereof may be made within the scope of the invention as defined in the appended claims.

I claim:

1. A method of providing operational commands to a AV program transmitted using HTTP protocol, comprising:
storing an AV program in a server;
generating meta data in the server, wherein the meta data includes a mapping table associating time ranges for the AV program to byte ranges for the AV program;
transmitting the meta data and mapping table to a client/player associated with the server;
generating and transmitting a HTTP GET command from the client/player to the server as a function of a desired operational command; and
selecting appropriate I-frames in the server and transmitting the I-frames to the client/player in response to the HTTP GET command.

2. The method of claim 1 where said generating meta data in the server includes generating a meta file and a mapping table which relates relative time of the AV program to a files access point and data-block size.

3. The method of claim 2 wherein said generating and transmitting a HTTP GET command includes transmitting a file access point and data-block size information.

4. The method of claim 1 which includes storing the generated meta data in the server.

5. The method of claim 1 which includes not storing the generated meta data in the server.

6. A system for providing operational commands to a AV program transmitted using HTTP protocol, comprising:
an AV program stored in a server;
meta data generated by the server, including a mapping table associating time ranges for the AV program to byte ranges for the AV program;
a client/player associated with the server, which receives the meta data and the mapping table;
a HTTP GET command generated by the client/player and sent to the server as a function of a desired operational command; and
selection means in the server for selecting appropriate I-frames in the server, which I-frames are sent to the client/player in response to the HTTP GET command.

7. The system of claim 6 where said mapping table relates relative time of the AV program to a files access point and data-block size.

8. The system of claim 7 herein said HTTP GET command includes a file access point and data-block size information.

9. The system of claim 5 which includes storage facilities for the meta data in the server.

10. A method of providing operational commands to a AV program transmitted using HTTP protocol, comprising:
storing an AV program in a server;
generating a data packet in the server, wherein the data packet includes a mapping table associating time ranges for the AV program to byte ranges for the AV program;
transmitting the data packet and mapping table to a client/player associated with the server;
generating and transmitting a HTTP GET command from the client/player to the server as a function of a desired operational command; and
selecting appropriate I-frames in the server and transmitting the I-frames to the client/player in response to the HTTP GET command.

11. The method of claim 10 where said generating a data packet in the server includes generating a meta file and a mapping table which relates relative time of the AV program to a files access point and data-block size.

12. The method of claim 11 wherein said generating and transmitting a HTTP GET command includes transmitting a file access point and data-block size information.

13. The method of claim 10 which includes storing the generated data packet in the server.

14. The method of claim 10 which includes not storing the generated data packet in the server.
